(19) United States
(12) Patent Application Publication
(10) Pub. No.: US 2002/0171639 A1
(43) Pub. Date: Nov. 21, 2002

(54) Methods and apparatus for transmitting data over graphic displays

(76) Inventor: Gal Ben-David, Adi (IL)

Correspondence Address: Eitan, Pearl, Latzer & Cohen-Zedek, One Crystal Park, 2011 Crystal Drive, Suite 210, Arlington, VA, 22202-3709, US

(21) Appl. No.: 09/834,907

(22) Filed: Apr. 16, 2001

(51) Int. Cl. G09G 5/00; G09G 3/36

(52) U.S. Cl. 345/207

(57) ABSTRACT

A method including downloading data from an information source by light transmission to a receiver, the information source being displayable on a scan display screen and a non-scan display screen

### FIELD OF THE INVENTION

The present invention relates generally to methods and apparatus for transmitting digital data over graphic displays, and particularly to transmitting data over scan and non-scan graphic displays

### BACKGROUND OF THE INVENTION

Information transfer from cathode ray tube (CRT) based devices is well known in the art. In general, a CRT is an electron gun that projects a beam (or three beams, for color) of electrons against a luminescent screen at the opposite end of the tube, where a bright spot of light appears where the electrons strike the screen. Depending on the phosphor type, different colored light is generated at the screen position hit by the electron beam. However, the light then fades quickly in 10 to 60 microseconds. This time depends on the persistence of the phosphor coating inside the screen. In order to keep a picture on the screen for a longer period, the picture should be redrawn before it disappears from the screen. This is referred to as refreshing the screen.

To produce a picture on the screen, the electron guns start a beam directed at the top of the screen and scan very rapidly from left to right. They then return to the left-most position one line down and scan again, and repeat this to cover the entire screen. In performing this scanning or sweeping type motion, the electron guns are controlled by the video data stream coming into the monitor from the video card, in the case of a computer, or the video signal, in the case of a television, which varies the intensity of the electron beam at each position on the screen. This control of the intensity of the electron beam at each dot is what controls the color and brightness of each pixel on he screen. Some implementations of CRT devices use screen interlacing, wherein the electron beam scans the odd lines and even lines interchangeably.

The television tube is a form of cathode-ray tube in which the beam scans the screen 525/625 times to form a frame, with 60/50 interlace frames being produced every second. These values apply to the NTSC and PAL standards (National Television Standards Committee and Phase Alternation Line), respectively. Each frame creates a picture by variations in the intensity of the beam as it forms each line. Computer monitors, on the other hand, use higher number of lines (768 for XGA) and a higher refresh rate (up to 100 Hz).

The prior art includes various patents that describe methods for data transmission from CRT devices. For example, various proposals have been made for supplying binary coded data simultaneously with television broadcast signals at special small window locations on the CRT screen. Examples of such methods are described in U.S. Pat. No. 4,999,617 to Uemura et al. and U.S. Pat. No. 3,993,861 to Baer, both of which require photo sensor devices touching or closely focused at a data image on the CRT screen, and sometimes held with vacuum cups. In the method of Baer, transmissions are embedded into the video signal by means of screen cells. The cells are painted by digital hardware to short periods of black and white.

U.S. Pat. Nos. 5,488,571 and 5,535,147 to Jacobs et al., both assigned to Timex Corporation, describe a system for transferring data from a CRT video display monitor on a personal computer to a portable information device such as a multifunction electronic wristwatch. A CRT video display has a video signal generator providing raster scanning of the screen and a program for formatting the binary coded data into blocks of serial data bits, with start bit and stop bit. Basically, the serial data is transformed into black and white lines that are shown on top of the CRT. The blocks of data are supplied to the video signal generator in synchronism with raster scanning of the screen so as to provide an integral number of one or more blocks of data for each vertical frame, and modulated to vary the brightness of the screen and provide light pulses which are seen by the operator as the presence or absence of horizontal spaced lines or line segments on the CRT corresponding to the presence or absence of binary coded transmitter pulses. The portable information device is manipulated within the line of sight of the CRT screen and has a photo sensor to detect light pulses when the photo sensor is directed toward the screen. Signals from the photo sensor are amplified and filtered to remove ambient light source flicker and extraneous spurious light signals and to convert the receiver pulses to binary coded data blocks varying between high and low logic levels at a preselected pulse reception rate. The portable information device stores the received data for further use. Transmission of data is only in one direction—from the CRT to the portable information device, which is not designed to send information back to the CRT.

One problem in such a system concerns tile portable information device which is designed to receive data at a fixed or pre-defined data rate or baud rate, but which may need to receive data from CRT monitors having different vertical frame rates, different internal timing and different numbers of horizontal scan lines in each frame. Therefore, if the portable information device is designed to accept data transfer at 2400 baud and light pulses are being emitted morn the CRT at 2000 baud or 3000 baud, the data will be garbled and not received correctly. While a computer may be programmed so that it causes light pulses to be emitted at 2400 baud for correct reception, the program is designed for a monitor with known characteristics. Changing monitors or changing computers may render the data that is transferred to be unintelligible.

U.S. Pat. No. 5,570,297 to Brzezinski, et al., also assigned to Timex, attempts to solve the abovementioned problem. Brzezinski, et al. describes a method and apparatus for synchronizing the data transfer rate for downloading data from the CRT. The CRT displays a calibration pattern of spaced horizontal lines, which is transmitted to the portable information device where it is repetitively compared to a stored calibration character. An acceptable error free transmission is signaled by a preselected number of matches. An audible signal indicates that the transmission rate is acceptable. The CRT pattern line spacing is adjusted until the audible signal is heard. The selectable pulse repetition rate may be automatically changed in increments by periodically changing the separation between lines on the CRT until an audible output signal is heard and providing for an operator to halt the automatic process. Alternatively, the pulse repetition rate may be manually changed in increments by an operator, until an audible output signal is heard.

The abovementioned Timex patents are utilized in the TIMEX DATA LINK watch, commercially available from Timex. Another patent that expands upon the Timex patents is U.S. Pat. No. 5,652,602 to Fishman et al., assigned to Microsoft Corporation. Fishman et al., describes a system and method of serially transferring a sequence of data bits between a computer and a portable information device such as the TIMEX DATA LINK watch, using the CRT of the computer as a transmission medium. The computer is programmed to display sequential display frames on a frame-scanning graphics display device and to illuminate line segments within the display frames to represent individual data bits. Each line segment has a continuous length on the display device that produces an optical pulse of a corresponding duration. Each data bit is encoded as a different line segment length to produce an optical pulse for each data bit having a duration which is dependent on the value of the data bit. For example, a pulse representing a binary value of 0 has a duration that is relatively longer than that of a pulse representing a binary 1. A receiving device monitors the optical signal created by the CRT and detects rising signal edges. It interprets each rising edge as the beginning of a single bit. After detecting a rising edge, the receiving device waits for a pre-determined time and then samples the optical signal. If the pulse from the CRT is still present, the receiving device interprets the data bit as a binary 0. Otherwise, the receiving device interprets the data bit as a binary 1.

U.S. Pat. No. 4,807,031 to Broughton et al. describes a low-disturbance method. The basic method represents data by raising and lowering the luminance of successive horizontal lines within some designated viewing area. Because the average luminance of the two adjacent lines remains the same, the effect is not perceptible to the eye, but sensing of the alternate raising and lowering of the luminance by an appropriate receiver allows the data to be detected. Instead of a presentation of black and white lines, the method uses small deviations of line amplitude from the original video signal. The technique is equivalent to superimposing on the video signal a subcarrier frequency of 7.867 KHz (for an NTSC broadcast), which can be detected by appropriate filtering.

U.S. Pat. No. 6,094,228 to Ciardullo et al. describes a spread spectrum low-disturbance method. Data is transmitted in the form of groups of data bits called symbols. Each symbol has associated with it one of a predetermined number of longer sequences of “chips” called PN sequences The PN sequence transmitted for any symbol is divided into a multiplicity of lines of chips. Each line of chips is transmitted together with its inverse, in pair-wise fashion, by embedding them in respective pairs of line scans of the video signal. The disclosures of the foregoing patents are incorporated herein by reference.

The prior art (particularly the Timex patents) typically implements a communication system that is described generally with reference to FIG. 1.

The entire transmitting portion of the system is referred to as a transmitter 10. Data is emitted by an information source 11 and sent to an information destination 24 An encoder 12 translates the data into two-dimensional image information that is shown as scan lines 15 on a CRT screen 14. The operation of the CRT requires an electronic bean scan circuitry 13 that converts the image into a one-dimensional intensity signal.

The entire transmitting portion of the system is referred to as a receiver 20, which may be a portable device, such as a wristwatch or a personal digital assistant (PDA). A photo sensor 21 is placed within the line-of-sight of CRT screen 14 and collects the emissions of light from the phosphor layer. In general, the signal at the output of the photo diode is a one-dimensional electronic signal that is band-limited by the fading nature of the phosphor layer. Noise from ambient light sources and electronic circuits is also present at the received signal at the output of the photo sensor 21. An amplifier 22 amplifies and decodes this signal by methods that are different in the art.

Generally speaking, the scan nature of the CRT enables using a low cost point photo sensor, such as a photo diode, to obtain two-dimensional information from the screen 14 as a one-dimensional time signal.

However, other screen technologies may not implement screen scan mechanisms and are therefore not compatible with the abovementioned methods Liquid Crystal Display (LCD) technology is an example of such non-scan displays. LCDs are becoming popular since they are thinner and lighter and draw much less power than cathode ray tubes (CRTs). LCDs rely on the special properties of a group of chemicals called liquid crystals that are transparent and whose molecules are twisted. The twist of the molecules changes the polarization of the transmitted light The angle of the change may be controlled by subjecting the crystal to an electric field. These properties have been used to develop displays that use the crystals to control the amount of light that is passed through the display.

The simplest and therefore lowest cost form of LCD addressing is passive matrix addressing. In this scheme, transparent conductive lines for the rows and columns are applied to the glass above and below the liquid crystal material. When a voltage is applied between the two points, the crystal realigns, changing the light transmission. In order to set different brightness levels for individual pixels, rows are set sequentially.

When a row is selected, the appropriate voltages are fed to individual column driver circuits. Current flows through the column lines to the selected row and the liquid crystal materials align accordingly. The drive circuits then move to the next row and repeat the operation. When the scanned row reaches the bottom of the display, the drive circuit starts again at the top of the display.

This kind of scheme may cause a lot of flicker, so the liquid crystal material is preferably chosen to have a slow response time. In other words, after the field aligns the crystal, the crystal takes quite a long time to return to its unaligned state. The slow response means that the fast scanning mechanism will not be seen by a photo diode placed against the screen.

Another LCD technology is known as active LCD, which uses an electronic switch at every pixel position so that once a pixel is switched on; the switch can maintain the field. The switch, which is usually a thin film transistor (TFT), also isolates the pixel from the influence of adjacent pixels and eliminates crosstalk. The steady nature of the display means that no scanning mechanism is seen by the photo diode.

One of the major parameters that limit the rate of information transfer from an LCD screen is the response time of the display. FIG. 2 illustrates the response time for a white-to-black change (t_{R}) as well as a black-to-white transition (t_{F}).

Typical values for active matrix LCD modules (taken from LTM150XS-T01 datasheet from Samsung Semiconductors Inc., 3655 North First Street, San Jose, Calif. 95134) are t_{R}≈20 mS, t_{F}≈40 mS. These values are only typical and are not fixed over the operating temperature range.

Another limiting factor of signal transmission is the non-linearity of the communication system. Digital information is encoded by setting the electronic control signals. Decoding is performed by a photo-sensor. In FIGS. 3A and 3B, the transfer characteristics of the photodiode output voltage vs. intensity control command is shown for CRT and LCD screens, respectively. The test was performed with a CRT Screen CM715 from Hitachi (2000 Sierra Point Parkway, Brisbane, Calif. 94005-1835), the display of an E500 notebook computer from Compaq (20555 State Highway 249, Houston, Tex. 77070) and an OPT210 photodiode (by Burr Brown Corp. PO Box 11400 Tucson, Ariz. 85734).

### SUMMARY OF THE INVENTION

The present invention seeks to provide a method and system for transmitting data over scan and non-scan graphic displays, and downloading the data to a receiver. Unlike the prior art, the invention is dual-mode, i.e.) both scan (e.g., CRT) and non-scan (e.g., LCD) screens may be used to transmit the data from an information source. The dual-mode capability is particularly advantageous, because it is not always possible to detect or know in advance if a screen is a scan or non-scan screen. Since the present invention provides dual-mode capability, the data may be transmitted regardless of the screen type.

The invention provides several methods for modulating light transmission from either type of display screen (scan or non-scan). One method includes changing the light transmission between a plurality of gray levels displayed on the screen, wherein a bit of data is represented by a dark-to-light transition and/or a light-to-dark transition. Another method includes a plurality of gray levels and decoding the light transmission back to the original data by determining the inverse of a transfer characteristic function of the light transmission, such as by means of a Look-Up-Table (LUT). These and other methods are described in detail hereinbelow.

The invention thus provides a method and apparatus for serially transferring a sequence of data bits between an information source and a portable information device (i.e, receiver) using a scan or non-scan screen as a transmission medium. For a CRT screen, the transmitter of the invention may be programmed to sequentially display frames on a frame-scanning CRT device and to illuminate segments within the display frames to represent information bits. However, the slow-decay nature of the CRT phosphor may cause interference among channel bits when trying to transmit at speeds that are higher than 50,000 channel symbols per second. A compensation method to overcome this problem, in accordance with a preferred embodiment of the present invention, is described in detail hereinbelow.

There is thus provided in accordance with a preferred embodiment of the present invention a method including downloading data from an information source by light transmission to a receiver, the information source being displayable on a scan display screen and a non-scan display screen.

In accordance with a preferred embodiment of the present invention the downloading includes collecting an emission of light from at least one of a scan display screen and a non-scan display screen, and filtering signals associated with emission of light from any combination of the scan and non-scan display screens to a common reception level.

Further in accordance with a preferred embodiment of the present invention the light transmission of the data is modulated, such as by means of pulse modulation (PM), pulse place modulation (PPM), pulse width modulation (PWM), amplitude modulation (AM), return to zero (RZ), non-return to zero (NRZ) or binary interval modulation, for example.

Still further in accordance with a preferred embodiment of the present invention the modulating includes changing the light transmission between a plurality of gray levels displayable on a screen.

In accordance with a preferred embodiment of the present invention the modulating includes representing a bit of data by at least one of a dark-to-light transition and a light-to-dark transition,

Further in accordance with a preferred embodiment of the present invention the modulating includes representing the bit by a time interval between two adjacent transitions.

Still further in accordance with a preferred embodiment of the present invention the light transmission received by the receiver is decoded back to the data.

In accordance with a preferred embodiment of the present invention the tight transmission is characterized by a transfer characteristic function, and further including decoding the light transmission back to the data by determining an inverse of the transfer characteristic function.

Further in accordance with a preferred embodiment of the present invention the determining includes estimating the inverse of the transfer characteristic function by means of a Look-Up-Table (LUT).

Still fixer in accordance with a preferred embodiment of the present invention the modulating includes dithering the light transmission.

Additionally in accordance with a preferred embodiment of the present invention the modulating includes separating the light transmission into a plurality of spectral colors.

In accordance with a preferred embodiment of the present invention the data is downloaded generally in parallel from a plurality of the information sources by light transmission to at least one receiver.

Further in accordance with a preferred embodiment of the present invention the light transmission includes presenting a plurality of synthetic images that include the data.

Still further in accordance with a preferred embodiment of the present invention the presenting includes displaying the images on a screen synchronously with a refresh process of the screen

Additionally in accordance with a preferred embodiment of the present invention the displaying includes using a plurality of memory image-buffers, wherein contents of one of the buffers is displayed on the screen while contents of the other buffers are background updated.

In accordance with a preferred embodiment of the present invention the method further includes switching between the buffers after background updating contents of the other buffers.

There is also provided in accordance with a preferred embodiment of the present invention apparatus including an information source displayable on a scan display screen and a non-scan display screen, and a receiver adapted to download data from the information source by light transmission thereto.

In accordance with a preferred embodiment of the present invention a transmitter is adapted to transmit the data on a scan and/or non-scan display screen.

Further in accordance with a preferred embodiment of the present invention the transmitter includes an encoder adapted to encode the data from the information source into at least one-dimensional image information.

Still further in accordance with a preferred embodiment of the present invention the transmitter includes a screen driver adapted to display the at least one-dimensional image information on a screen. For example, the screen driver may be a cathode ray tube (CRT) driver in communication with a CRT screen. Alternatively, as another example, the screen driver may be a liquid crystal display (LCD) driver in communication with an LCD screen.

In accordance with a preferred embodiment of the present invention the receiver includes a photo sensor adapted to collect an emission of light from at least one of a scan display screen and a non-scan display screen.

Further in accordance with a preferred embodiment of the present invention the receiver includes a filter adapted to filter emission from any combination of the sol and non-scan display screens to a common reception level

In accordance with a preferred embodiment of the present invention the receiver is disposed in a component of at least one subscriber identity module (SIM) card of a mobile phone. The component may be a battery of the at least one SIM card, for example.

Further in accordance with a preferred embodiment of the present invention a device is provided that is in communication with the receiver, the device being operable by means of the data decoded by the decoder. The device may include an irrigation controller, a smart card, a credit card, an electronic coupon, a programmable portable device, a controller, a toy, a personal digital assistant (PDA), a video verification device, a video watermarking device, a loadable greeting card or a loadable multimedia device, for example.

Still further in accordance with a preferred embodiment of the present invention the receiver includes a plurality of photo sensors adapted to collect an emission of light generally in parallel from a plurality of the information sources by light transmission to the photo sensors.

Additionally in accordance with a preferred embodiment of the present invention the photo sensors include at least one of a one-dimensional photo sensor, a two-dimensional photo sensor, and a CCD sensor.

There is also provided in accordance with a preferred embodiment of the present invention a method including receiving a plurality of signals from a scan screen, the signals including light segments, and decoding the segments by determining a residual light effect of at least one of the light segments on a next light segment and subtracting the residual light effect from the received signals.

In accordance with a preferred embodiment of the present invention the determining includes determining a segment pulse shape of one of the light segments.

Further in accordance with a preferred embodiment of the present invention the determining includes determining a timing sequence of one of the light segments.

Still further in accordance with a preferred embodiment of the present invention the determining the segment pulse shape includes analyzing a pulse shape of at least one of the light segments by transmitting a single segment pulse with a known gray level, followed by transmitting a black screen.

Additionally in accordance with a preferred embodiment of the present invention the method further includes decoding at least one of a shape and timing of the segment pulse with a pulse height and placement decoding unit.

In accordance with a preferred embodiment of the present invention the method further includes storing the at least one of the shape and timing of the segment pulse in a decoded pulse FIFO (first in, first out) memory unit.

Further in accordance with a preferred embodiment of the present invention non-linearity of at least one of the light segments is corrected such as by means of a Look-Up-Table (LUT) or by dithering at least one of the light segments.

### BRIEF DESCRIPTION OF THE DRAWINGS

The present invention will be understood and appreciated more filly from the following detailed description taken in conjunction with the appended drawings in which:

FIG. 1 is a block-diagram illustration of a prior art method for downloading information from a scan screen;

FIG. 2 is a graphical illustration of photodiode output voltages during black-to-white and white-to-black transitions;

FIGS. 3A and 3B are graphical illustrations of the transfer characteristics of the photodiode output voltage vs. control command for CRT and LCD screens, respectively (prior art);

FIG. 4 is a simplified block diagram illustration of a transmitter for transmitting data from either a scan screen or a non-scan screen, constructed and operative in accordance with an embodiment of the invention;

FIG. 5 is a simplified pictorial illustration of a transmission window displayable on either a scan screen or a non-scan screen for transmission of the data in accordance with an embodiment of the invention;

FIG. 6 is a simplified block diagram illustration of a receiver for receiving data from either a scan screen or a non-scan screen, constructed and operative in accordance with an embodiment of the invention;

FIG. 7 is a simplified graphical illustration of interval modulation of the transmitted data, useful for either a scan screen or a non-scan screen, in accordance with an embodiment of the invention;

FIG. 8 is a simplified graphical illustration of a look-up-table compensation, used for decoding data received from either a scan screen or a non-scan screen, in accordance with an embodiment of the invention;

FIG. 9 is an illustration of a comparison of diner with gray scale;

FIG. 10 is a simplified block diagram illustration of the receiver of FIG. 6 embedded in a SIM of a cellular phone battery, constructed and operative in accordance with an embodiment of the invention;

FIG. 11 is a simplified block diagram illustration of the receiver of FIG. 6 incorporated in a system for irrigation control, constructed and operative in accordance with an embodiment of the invention;

FIG. 12 is a graphical illustration of a CRT screen response of a photo sensor to a single pixel (prior art);

FIG. 13 is a simplified schematic illustration of transmitting six channel symbols with a computer CRT, in accordance with an embodiment of the invention:

FIG. 14 is a simplified graphical illustration of a typical response to a data segment of the CRT transmission of FIG. 13;

FIG. 15 is a simplified graphical illustration of the inter symbol interference (ISI) for the data segments of the CRT transmission of FIG. 13; and

FIG. 16 is a simplified schematic illustration of decoding circuitry used in a method for achieving higher channel symbol rate in CRT transmission and avoiding ISI, in accordance with an embodiment of the invention.

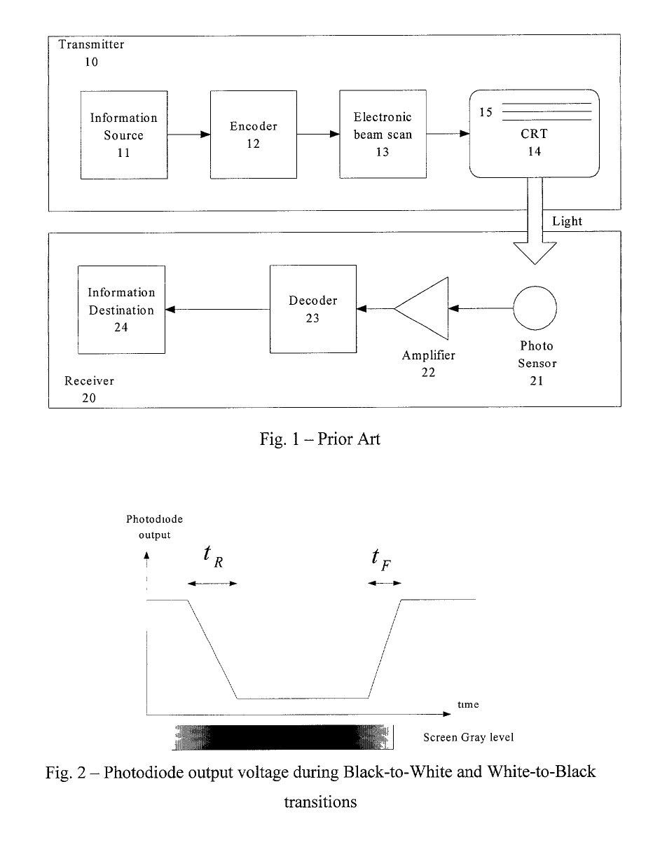

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein This apparatus may be specially constructed for the desired purposes, or it may comprise a general-purpose computer selectively activated or reconfigured by a computer program stored in the computer, Such a computer program may be stored in a computer readable storage medium, such as, but is not limited to, any type of disk including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories EEPROMs), magnetic or optical cards, or any other type of media suitable for storing electronic instructions, and capable of being coupled to a computer system bus.

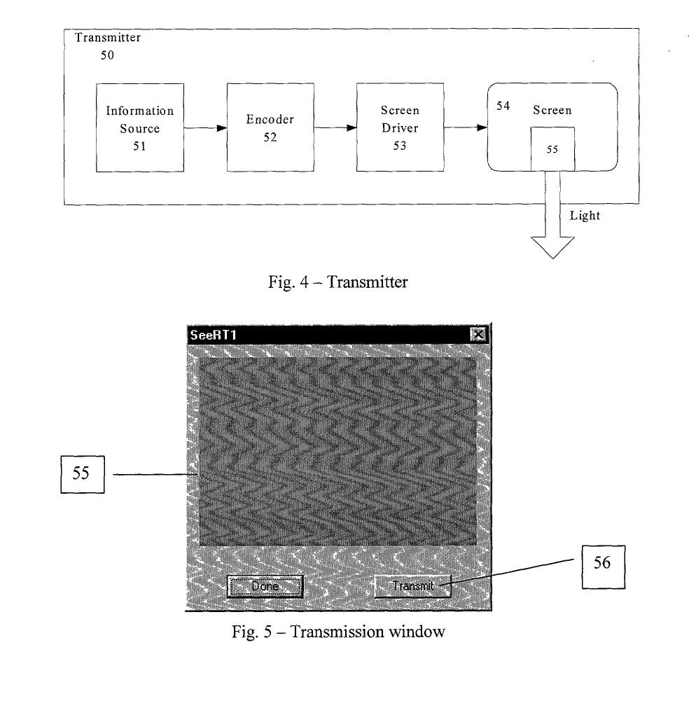

Reference is now made to FIG. 4, which illustrates a transmitter 50 for transmitting data from a screen 54, constructed and operative in accordance with an embodiment of the invention. Digital data is preferably provided by an information source 51, An encoder 52 may translate the data into one or two-dimensional image information that is shown by a screen driver 53 on a screen 54. Unlike the prior art, screen 54 may be either a scan screen (such as, but not limited to a CRT screen) or a non-scan screen (such as, but not limited to an LCD screen),

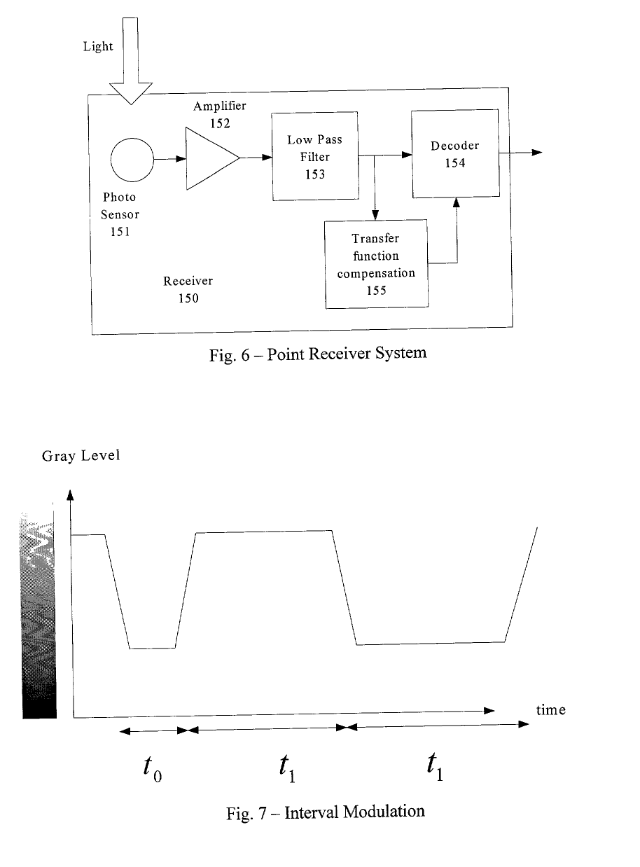

A portion or all of screen 54 may be reserved for a transmission window 55, used for modulating the data and transmission thereof to a receiver, as described now with farther reference to FIG. 5. A user may place a receiver (not shown in FIG. 5, but described further below with reference to FIG. 6) in close proximity to screen 54. (The receiver is preferably, although not necessarily, portable.) A transmit button 56 is preferably provided with screen 54 or transmission window 55. Button 56 may be activated by any convenient method, such as by pressing or clicking with a mouse, for example. Activation of button 56 preferably causes transmitter 50 to present a series of images on transmission window 55, such as by means of software comprised by transmitter 50 in screen driver 53 or a pre-programmed software unit (not shown). These images are decoded by the receiver, as is described hereinbelow.

In the case of a television screen, a portion of the television screen may be dedicated for transmission, in parallel with normal TV broadcast. Applications of such transmission are, but not limited to, advertising of coupons, cookbook recipes, channel identification, and program schedule information.

Reference is now made to FIG. 6, which illustrates a receiver 150 for receiving data from either a scan or non-scan screen) constructed and operative in accordance with an embodiment of the invention. Receiver 150 receives optical information from transmission window 55 and decodes the transmitted information. A photo sensor 151 is preferably placed within a line-of-sight of the screen 54 and collects the emissions of light from the screen 54. A suitable (but non-limiting) example of a photo sensor is the OPT210 photodiode, commercially available from Burr Brown Corp., PO Box 11400, Tucson, Ariz. 85734.

An amplifier 152 preferably amplifies the signal received by photo sensor 151, and a filter 153, such as, but not limited to, a low pass filter, filters the amplified signal. In a preferred embodiment of the invention, a low pass filter, typically up to 30Hz, filters out ambient light (50/60 Hz-100/120 Hz) and screen vocal refresh rate (50-100 Hz) as well as high frequency noise, Such filtering may bring both LCD and CRT screens to a common reception level, A decoder 154 decodes the light transmission received by receiver 150 back to the transmitted data, as is described more in detail hereinbelow.

Those skilled in the at will appreciate that the screen-to-photo sensor channel may be data modulated to convey information in a variety of ways, including, but not limited to, pulse modulation (PM), pulse place modulation (PM), pulse width modulation (PWM), amplitude modulation (AM), return to zero (RZ), non-return to zero (NRZ) or any other temporal modulation and coding technique.

Reference is now made to FIG. 7, which illustrates one method of data modulation that is compatible with both LCD and CRT screens, the method being binary interval modulation. Binary interval modulation comprises changing between two gray levels to modulate the data transmission from transmission window 55 of screen 54.

The use of only two gray levels eliminates he problems arising from the non-linearity limitation, mentioned hereinabove in the background of the invention. Each transition, either dark-to-light or light-to-dark, represents a binary digit (bit). The interval between adjacent transitions is set according to the bit to be decoded Zero is represented by t₀, while one is represented by t₁. Accordingly, as seen in FIG. 7, only the time period between two adjacent transitions is important and a “one” bit may be represented by either a dark-to-light transition, or by a light-to-dark transition.

At the decoder 154, the intervals between transitions are decoded back to the digital data. An advantage of tis embodiment is that it has an inherent clock recovery mechanism (self-clocking). Synchronization is performed by voltage change detection and the decoder 154 does not need to recover the data clock by means of a phased locked loop (PLL) or any other method

Persons skilled in the art will understand that the transition limitation of the LCD screen, for example, limits the bit rate of any binary modulation to around 30-50 bits per second. In order to overcome the relative low bit rate of the binary modulation, multiple gray levels may be implemented to achieve higher bit rates. The use of several possible signal levels for channel transmission is well known in the art. In general, N gray levels increase the bit rate by log₂ N, In current circumstances, the non-linearity of the channel as discussed earlier requires the implementation of a transfer compensation device 155 (FIG. 6), also referred to as a transfer function compensation device.

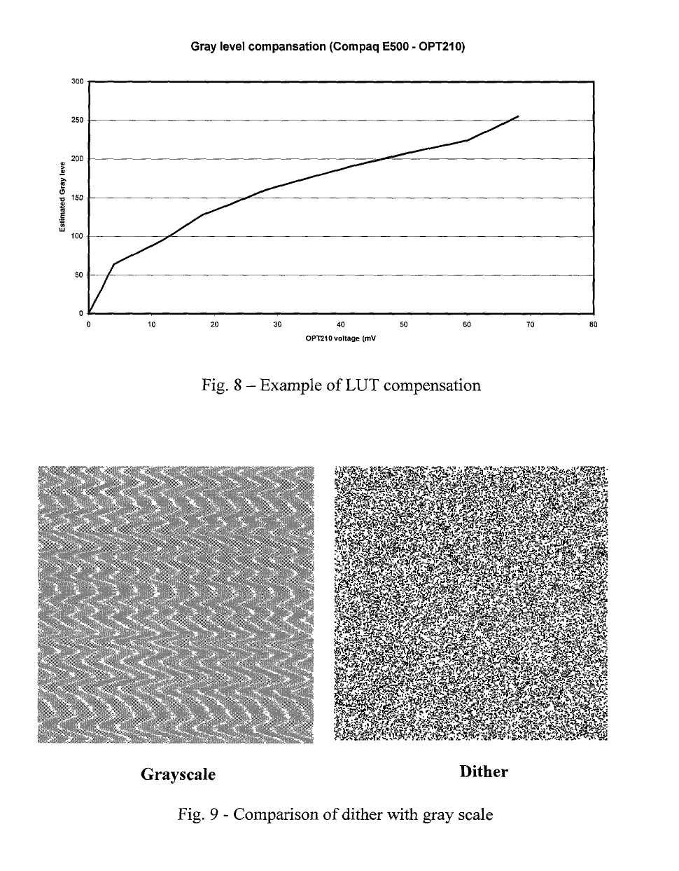

The transfer compensation device 155 stores information on the transfer characteristics of the system. This is done in a preferred embodiment by means of a Look-Up-Table LUT), described with reference to FIG. 8. The LUT enables the decoder 154 to perform an estimation of the inverse of the characteristic function. The compensation device 155 may be programmed by the manufacturer when the channel properties are known in advance, or by a training phase prior to transmission. During the training phase, the transmitter 50 sends a series of light intensities that is known to the receiver 150. The receiver 150 builds the LUT by means of inverse function estimation. In a preferred embodiment, up to 256 gray levels (intensity command) are used. During the training phase, the transmitter 50 emits a series of the evenly spaced gray levels: 0, 32, 64, 96, 128, 160, 192, 224, 255. This training phase, which may be typically required only once per transmission, may require around 300 mS. The receiver 150 builds a piecewise linear estimation of the transfer characteristics, as seen in FIG. 8.

Use of transfer compensation device 155 may be obviated by using dithering techniques. Dithering is a known method for the perceptual representation of color and gray levels by lower resolution levels, mostly black and white. An example of dithering is shown in FIG. 9, where the same command is given by either gray level or by a dithered frame. The dithering approach is used here to improve the linear response of the system instead of its original application in improving by means of a common resolution.

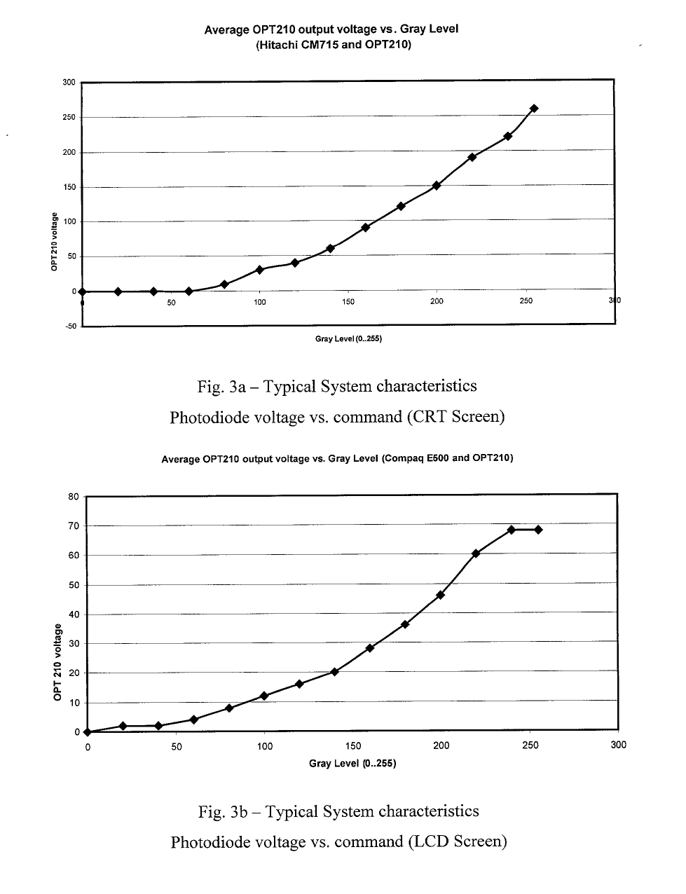

The photo sensor 151 collects light from transmission window 55, as mentioned above, and emits a current or voltage level Nat is closely proportional to the average of its response to the light emitted from all image pixels in its field of view. For example, with 50% black pixels and 50% white pixels, the photo sensor response is very close to halfway between the response to full white and the response to full black. This is much better that the test results shown in FIGS. 3A and 3B, where a gray level of 128 (“half white”) in a software command results in a photodiode response that is close to 25% of the response to full white.

Data throughput may also be increased by using spectral diversity. In a preferred embodiment, he basic LCD color pixels (red, green and blue) are used for transmission of three channels in parallel. Three photo sensors may be used and covered with a red, green or blue integral filter stripe for spectral separation.

Another method to achieve higher bit rates is by using parallel transmission areas and a group of photo sensors. Each screen-area to photo sensor channel may use the methods described hereinabove for photo sensor 151 (which may be a point sensor).

Parallel photo sensors may be one-dimensional or two-dimensional. In a preferred embodiment, a CCD sensor may be used. An example of a one-dimensional receptor is KLI-2113 color array commercially available from Eastman Kodak Company, 343 State Street, Rochester, N.Y. 14650. The device contains 3 rows of 2098 active photo-elements, comprising high performance PIN diodes. Each row is selectively covered with a red, green or blue integral filter stripe for spectra separation. Readout of the pixel data for each channel is accomplished through the use of a shift register.

The receiver 150 or 60 of the present invention may be incorporated in a variety of devices and applications, such as, but not limited to, a smart card, a credit card, an electronic coupon, a programmable portable device, a controller, a toy, a personal digital assistant (PDA), a video verification device, a video watermarking device, a loadable greeting card and a loadable multimedia device. Two applications are now described more in detail.

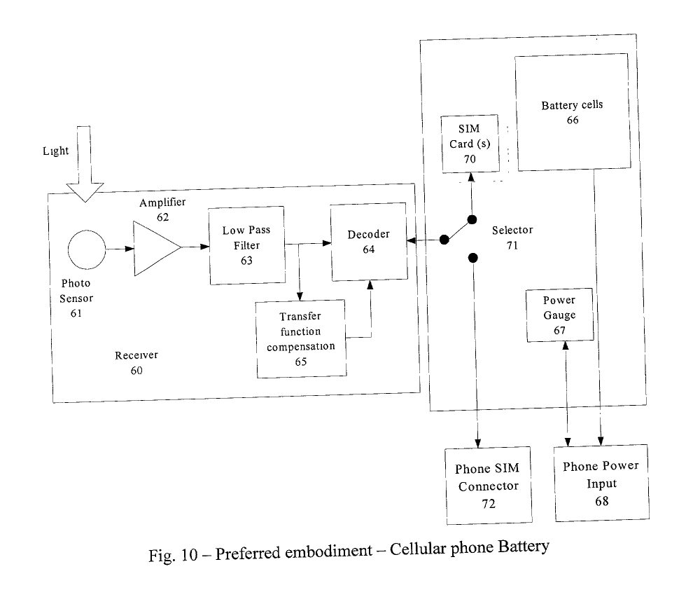

Reference is now made to FIG. 10, which illustrates the receiver 150 of FIG. 6 embedded in an adapter (placed inside a battery) connected to one or more subscriber identity modules (SIMs) of a cellular phone, in accordance with au embodiment of the invention.

One of the most widely used digital network telecommunications systems is GSM (global system of mobile communications), which is currently operating in over 100 countries around the world, particularly in Europe and Asia Pacific

Most GSM cellular phones use a SIM card, which comprises an electronic chip placed in a small printed circuit board that must be inserted in any GSM-based mobile phone when signing on as a subscriber. The SIM card contains subscriber details, security information and memory for a personal directory of numbers. Hardware of the SIM card is based on the standards defined in GSM 11.11 Chapter 4 and 5, GSM 11.12, and ISO 7816 Part 1 and 2. The Plug-in SIM has a width of 25 mm, a height of 15 mm, a thickness the same as an ID-1 SIM, and a feature for orientation. An example of a SIM card is GoldKey Phase II from GoldKey, Prosperity Rd. II, Science-Based Industrial Park, Hsinchu, Taiwan, R.O.C.

As mentioned previously, the SIM card may hold various data records including personal information, names and phone numbers as well as electronic money. Loading of the SIM card using the cellular phone keyboard may be cumbersome in the prior art. Loading a list of few tens of contacts, for example, may take few hours. On the other side, the information exits electronically in many cases on a personal computer or within a public database. Therefore, it would be desirable to enable loading of data from a television or a personal computer into the SIM card. Most TV sets and computers, however, do not have a smart card reader onboard.

The use of a battery as an access method to the SIM card is known in the art. Designs are also known aimed at using two SIM cards in a cellular phone. The present invention exploits the availability of the mobile phone battery as seen in FIG. 10.

In a similar fashion to the receiver 150 described with reference to FIG. 6, the embodiment of FIG. 10 comprises a receiver 60 for receiving data from either a scar or non-scan screen. Receiver 60 receives optical information from transmission window 55 (FIG. 5) and decodes the transmitted information. A photo sensor 61 is preferably placed within a line-of-sight of the screen 54 (FIG. 4) and collects the emissions of light from the screen 54. An amplifier 62 preferably amplifies the signal received by photo sensor 61, and a filter 63, such as, but not limited to, a low pass filter, filters the amplified signal. A decoder 64 decodes the light transmission received by receiver 60 back to the transmitted data, as is described in detail hereinabove. A transfer compensation device 65 may be used as described hereinabove.

Information obtained from the receiver 60 is transferred to one or more SIM cards 70 associated with a battery of a cell phone (also called mobile phone). In one embodiment, the information is a collection of names and phone numbers. A selector 71 may be provided at changes the connection of the SIM card(s) between the phone, via a phone SIM connector 72, and the optical decoder 64. The ISO 7816 standard defines the I/O connections to be of “open collector” type. The I/O line in the terminal may be tied to a high voltage level (e.g., 5V) via a pull up resistor (typically 20 KΩ). Preferably, both the phone and the SIM card do not send all active high voltage level. This is commonly known as a “wire-OR” bus. Those who are stilled in the art will appreciate that with such a bus structure, it is possible to use the decoder 64 and phone SIM connector 72 as bus mats sharing the same bus, using no specialized selector.

The main block of the battery preferably includes battery cells 66 and a power gauge chip 67, which communicate with a phone power input 69, and which are used as in normal operation of the phone.

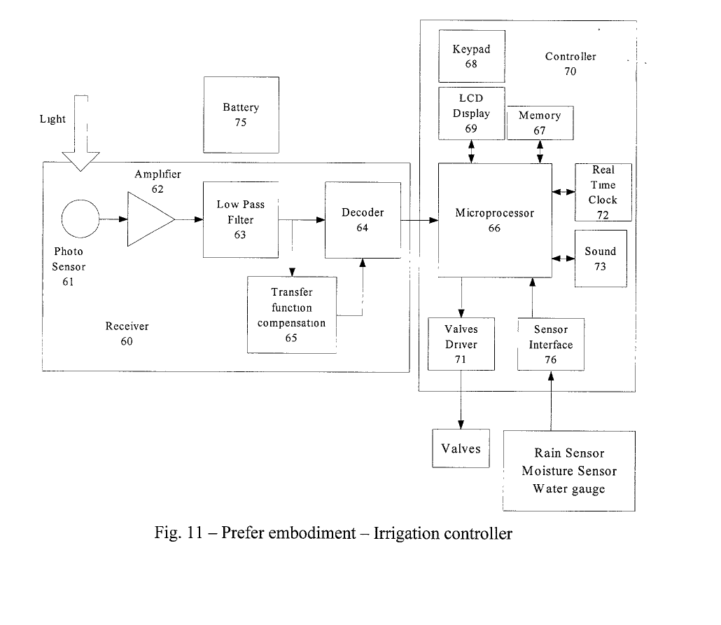

Another application of the receiver of the present invention is now described with reference to FIG. 11, which illustrates the receiver 60 of FIG. 10 incorporated in a system for irrigation control, constructed and operative in accordance with an embodiment of the invention

Information obtained from the receiver 60 is transferred to a controller 170 of the system for irrigation control. The information received may be stored by a microprocessor 166 in a memory 167. In a preferred embodiment, the information is a collection of structures describing times to open and close valves, in terms of day of the week and time in a one-minute resolution. An optional sound device 173 “beeps” when the entire information is received from the host computer. A real time clock 172 may be used to determine the current day of the week and time. Generally only two bytes are needed to update the real time clock 172 to synchronize with the host computer.

External devices 179, such as a rain sensor, moisture sensor and water gauge may be added to improve water usage. The controller may have a sensor interface 176 to interface with such devices. An optional keypad 168 and LCD screen 169 may provide a user interface. Dedicated valve drivers 171 may drive water valves 159.

In another embodiment, the receiver 60 is detachable from the controller 170, and the controller 170 may be installed away from the programming computer. In order to program the controller 170, a user may detach the receiver 60 and place it in close proximity to the computer screen 54 (FIG. 4), After information download to the receiver assembly is complete, the user may reattach the receiver portion back onto the controller 170.

In one embodiment, time may be stored in a resolution of minutes in cycles of up to one week. Since there are 10,080 minutes in a week, those skilled in the art will appreciate that time information in such an embodiment may be kept in two bytes of memory, while keeping two free bits.

The information that may be transferred in the embodiment of FIG. 11 is described in Table 1.

TABLE 1
Controller programming information

| Information | Size in bytes |
|---|---|
| Current time | 2 |
| N — Number Of Open Valve - Close Valve structures | 1 |
| N Times | |
| Open Valve Time + 2 bits for Valve Number | N x 2 |
| Close Valve Time + 2 bits for Valve Number | N x 2 |
| CRC | 2 |
| Total | 5 + 4 x N |

Current time may be transmitted in order to synchronize the controller's real time clock 172 with the computer clock, and the transmission integrity of the controller 170 may be verified by a cyclic redundancy code. When the information is verified, the receiver may signal the user by placing a message on its LCD screen or by creating a “beep” sound.

The foregoing disclosure has described a method and apparatus of serially transferring a sequence of data bits between an information source 51 and a portable information device (receiver 150 or 60) using the CRT (screen 54) of a computer or a television as a transmission medium.

The transmitter 50 may be programmed to sequentially display frames on a frame-scanning CRT device and to illuminate segments within the display frames to represent information bits.

In a preferred embodiment, a computer program presents a series of synthetic images that contains the information bits. Those skilled in the art will appreciate that the presentation of these images should be done in a fast way that is preferably synchronous with the screen refresh process. In a preferred embodiment, MICROSOFT DIRECTDRAW technology may be used for that purpose. For the desired method, two memory image-buffers are maintained. The two buffers are used in a double buffering technique; one is shown on the screen while the other is updated in the background. Background update includes drawing of line segments is a way that is explained further hereinbelow. When background updating is done, the two buffers are flipped. The background buffer turns into the foreground buffer and vice versa. The buffer flip is synchronized with the screen refresh by the computer video display card.

As mentioned several times hereinabove, the present invention provides systems and methods for transferring sequences of data bits between a data source and a portable information device using either a scan or non-scan graphic display as the transmission medium. The present invention also provides methods for overcoming certain well-known problems that may be associated with CRT graphic displays.

Specifically, a known problem that may exist with CRT screens is the slow-decay nature of the CRT phosphor (around 10-20 microseconds), which may cause interference among channel bits when trying to transmit at speeds that are higher than 50,000 channel symbols per second. A compensation method to overcome this problem, in accordance with a preferred embodiment of The present invention, is described hereinbelow.

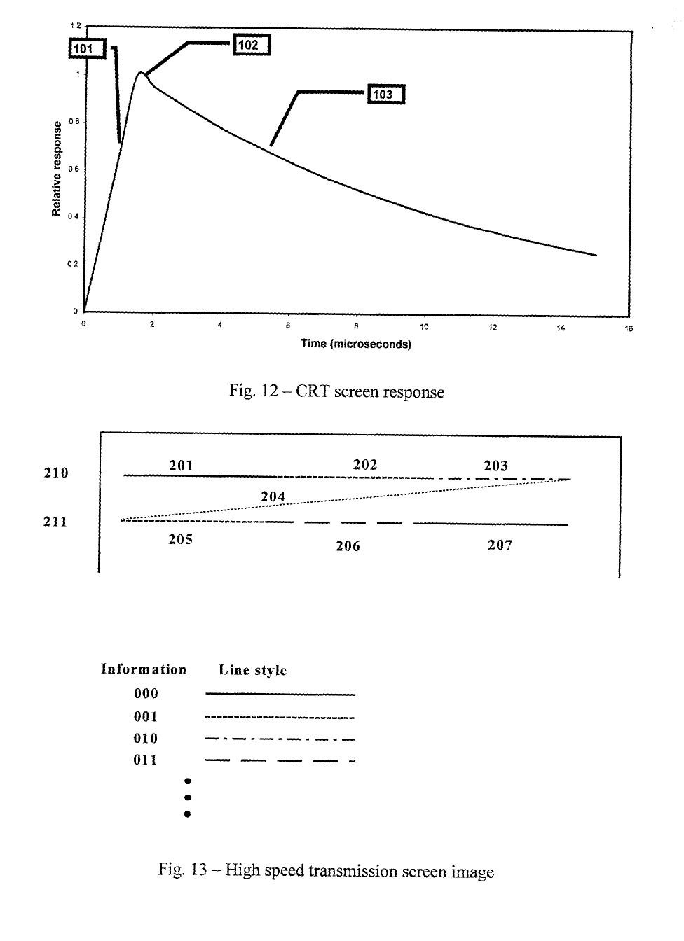

The scan process of the CRT progressively illuminates all screen pixels. The electrical response of the receiver photo-sensor is a convolution sum of responses to individual pixels. A simplified response of the photo sensor to a single pixel is shown in FIG. 12.

When the phosphor is energized by the electron beam, it builds up brightness in a brightness pulse 102 during an excitation period 101. Afterwards, the brightness decays during a period of time 103 determined by the persistence of the phosphor. The relative amplitude of the brightness pulse 102 is a function of the electronic command given by either luminance (gray level) or chrominance information. In a preferred embodiment, only luminance encoding is used. It will be appreciated by skilled artisans that usage of chrominance encoding is analogous. The transfer function of the photo sensor response versus gray level command is non-linear, as discussed hereinabove with reference to FIG. 3A. The non-linearity problem may be solved by the use of a plurality of gray levels or with a Look-Up-Table, as described hereinabove with reference to FIGS. 7 and 8, respectively, or by using a one-dimensional black and white dither

The decay period of the phosphor complicates the possibility of using channel symbol-periods that are shorter than this decay interval. In such cases, one symbol is interfered by the residual light of previously transmitted symbols. This problem is known in the art as inter symbol interference (ISI).

In one preferred embodiment, the transmitter 50 (FIG. 4) may use a computer CRT screen with 800 columns by 600 lines resolution and a refresh rate of 72 Hz, with a total of 43,200 scan lines per second. It should be appreciated that different resolutions and refresh rates are also applicable and within the scope of the invention. Using this screen setup, the line scan period is about 16 microseconds followed by a horizontal blanking period of around 4 microseconds. In order to avoid ISI, it is preferable to transmit only one channel symbol per screen line, limiting performance to 43,200 channel symbols per second,

In another embodiment, the transmitter 50 may use an NTSC television CRT screen with 640 columns by 241 active video lines and a refresh me of about 60 Hz, with a total of about 14,460 lines per second. Using this screen setup, the line scan period is about 52 microseconds followed by a horizontal blanking period of around 11 microseconds. In order to avoid ISI, it is preferable to transmit only four channel symbols per screen line, limiting performance to 57,840 channel symbols per second.

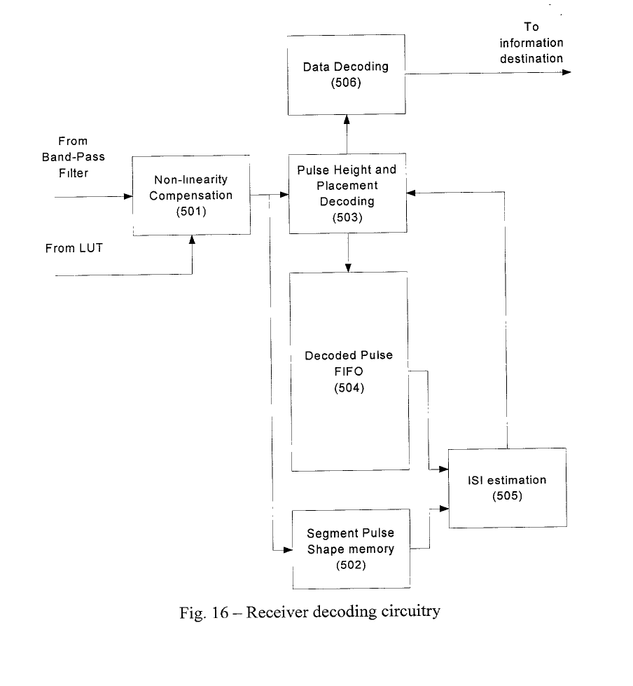

In order to achieve higher channel symbol rate, a method in accordance with another embodiment of the present invention is provided for avoiding ISI, as described hereinbelow with reference to FIG. 16. This method enables includes transmitting three channel symbols with a computer screen CRT presenting a resolution of 800 columns by 600 rows at 72 Hz refresh rate, as seen with reference to FIG. 13. The method may increase the channel symbol rate to 129,600 symbols per second. Using an 8 gray levels (intensity levels) scheme, a bit rate close to 390,000 bits per second may be obtained. With NTSC television, similar techniques may be used to transmit more than four channel symbols per line.

For simplicity, only two consecutive lines 210 and 211 are shown in FIG. 13. In each line, three segments 201, 202 and 203 are displayed, each allocated to one third of the line. Different gray levels are shown here by different line styles. The first segment 201 is a gray level that represents three zero bits, the second segment 202 represents the bits 0, 0 and 1, the third segment 203 represents the bits 0, 1 and 0, and so on.

The photo diode response to a single line segment (one third of a scan line) is the convolution sum of the responses to all of its pixels. In a preferred embodiment, the response to a segment is a convolution sum of (800/3=) 266 responses to one pixel, wherein the pixel-interval is about 20 nanoseconds.

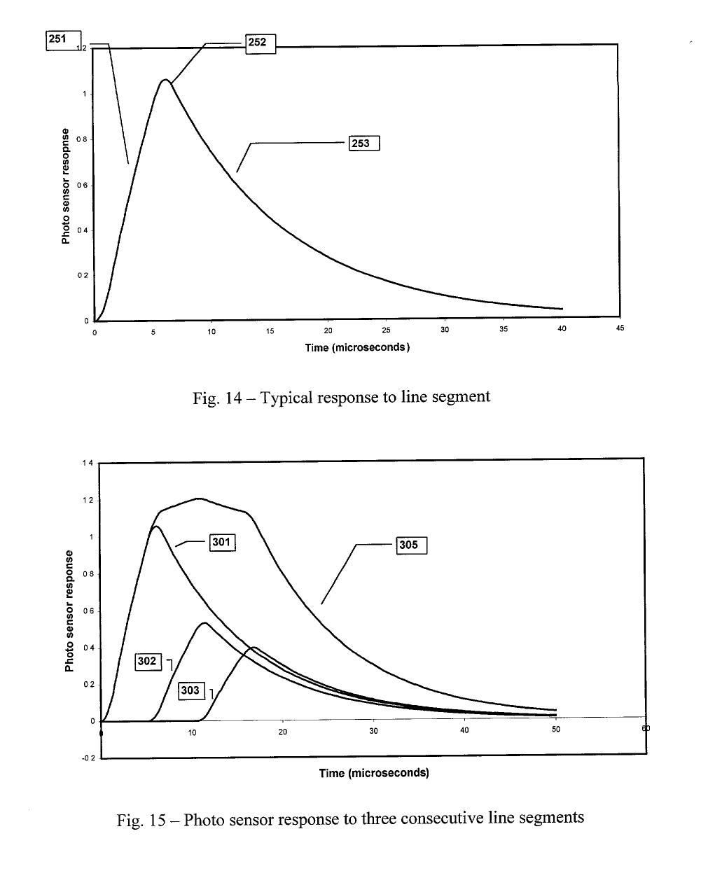

Reference is now made to FIG. 14, which illustrates a typical response to one of the data segments of FIG. 13. A rising edge 251 of the response is the accumulation of responses from more and more pixels. Due to the advantages of dither or the LUT compensation described hereinabove with reference to FIG. 8, a peak value 252 of the response is nearly linear to the gray level of the segment. As mentioned earlier, a falling edge 253 of the response may interfere with subsequent data segments.

Reference is now made to FIG. 15, which illustrates the inter-symbol interference for such data segments. Three segments 301, 302 and 303 of different gray levels are transmitted in a single screen line. As seen in FIG. 15, it is difficult to decode the original segments in an overall response 305.

Reference is now made to FIG. 16, which illustrates decoding circuitry used in the method for achieving higher channel symbol rate in CRT transmission and avoiding ISI, in accordance with an embodiment of the invention.

As described hereinabove with reference to FIG. 8, non-linearity compensation 501 of the channel may be accomplished using the LUT information. In order to reduce ISI, the decoder 154 or 64 generates an estimation of the residual light responses. This may be obtained by keeping a sample of the pulse shape as well as by using previously decoded pulses.

Alternatively, as similarly described hereinabove with reference to FIG. 9, non-linearity compensation 501 of the channel may be accomplished by a one-dimensional dither. This means, for example, that instead of the three segments 201, 202 and 203 (shown in FIG. 13) being constructed with different gray levels, the segments are constructed of a mixture of black and white pixels, One advantage of dithering is that it improves the linear response of the system, as mentioned hereinabove. Yet another advantage is the lower amount of bits per screen pixel that is needed. This reduces the speed requirements of the computer's screen adapter.

A sampled version of the segment pulse may be stored in a segment pulse shape memory 502. In a preferred embodiment, an 8 bit, 500 KHz A/D is used to sample signals at a 2 μsec sampling period. It is noted that this rate is higher than the symbol period that is close to 5 μsec .

In the first transmission (training) frame, a sampled version of the shape of the pulse is studied by the receiver and stored in the pulse shape memory (502). The shape of the segment pulse may be studied by the transmission of a single segment (with known gray level) followed by a black interval of at least few tens μsec. During the transmission itself, the height and timing of the light pulse due to the first segment may be easily decoded by a pulse height and placement decoding unit 503, since this segment pulse does not suffer from residual light caused by previous pulses. The information of pulse height and timing may be stored in a decoded pulse FIFO (first in, first out) memory unit 504. Staring with the decoding of the first pulse, tie residual effect of the pulse may be estimated based on the decoded height and timing and the sampled version of the pulse shape as kept in the memory (502).

An ISI estimation processor 505 preferably collects the information from the decoded pulse FIFO memory unit 504 and the segment pulse shape memory 502. The output of ISI estimation processor 505 is an estimation of the ISI, and is subtracted from the original signal by the pulse height and placement decoding unit 503. The second pulse is decoded after subtracting the fist segment's residual effect from the incoming signal. The second decoded pulse is then entered into the decoded pulse FIFO memory unit 504 in the same manner.

From now on, the history of pulse decoding is used to estimate the ISI. The ISI is subtracted from the received signal, making the decoding possible. It may be seen from FIG. 15 that in the preferred embodiment, the pulse residual is about ten times longer Can the pulse itself. In other words, the ISI memory is about ten times the pulse period and its influence may be dropped afterwards. The decoded pulse FIFO memory unit 504 is therefore preferably capable of storing pulse height and timing information for the last ten pulses,

It will be appreciated by those skilled in the art that in the embodiment of FIG. 16, that the CRT transmits pulses in a non-uniform timing sequence that is caused by the horizontal and vertical blanking periods. This is different from phone modems where pulses are sent in a uniform timing sequence and ISI is treated by sampling the channel pulse at the channel symbol rate. The non-uniform timing is a more complicated problem, but fortunately may be solved in the embodiment of FIG. 16 by a higher sampling rate of the pulse and the use of pulse timing for ISI estimation.

In summary, previously decoded symbols may be recursively used to subtract ISI from the current signal. Decoded timing may be used to improve the estimation of the ISI to be subtracted, especially in the case of non-uniform transmission timing. Non-linearity may be corrected by LUT or dithering, for example.

It will be appreciated by persons skilled in the art that the present invention is not limited by what has been particularly shown and described herein above. Rather the scope of the invention is defined by the claim hat follow:

What is claimed is:

1. A method comprising:
downloading data from an information source by light transmission to a receiver, said information source being displayable on a scan display screen and a non-scan display screen.

2. The method according to claim 1 wherein said downloading comprises collecting an emission of light from at least one of a scan display screen and a non-scam display screen, and filtering signals associated with emission of light from any combination of said scan and non-scan display screens to a common reception level.

3. The method according to claim 1 and further comprising modulating said light transmission of said data.

4. The method according to claim 3 wherein said modulating comprises at least one of pulse modulation (PM), pulse place modulation (PPM), pulse width modulation (PWM), amplitude modulation (AM), return to zero (RZ), non-return to zero (NRZ) and binary interval modulation.

5. The method according to claim 3 wherein said modulating comprises changing said light transmission between a plurality of gray levels displayable on a screen.

6. The method according to claim 5 wherein said modulating comprises representing a bit of data by at least one of a dark-to-light transition and a light-to-dark transition.

7. The method according to claim 6 wherein said modulating comprises representing said bit by a time interval between two adjacent transitions.

8. The method according to claim 1 and further comprising decoding said light transmission received by said receiver back to said data.

9. The method according to claim 5 wherein said light transmission is characterized by a transfer characteristic function, and further comprising decoding said light transmission back to said data by determining an inverse of said transfer characteristic fiction.

10. The method according to claim 5 wherein said determining comprises estimating said inverse of said transfer characteristic function by means of a Look-Up-Table (LUT).

11. The method according to claim 3 wherein said modulating comprises dithering said light transmission.

12. The method according to claim 3 wherein said modulating comprises separating said light transmission into a plurality of spectral colors.

13. The method according to claim 1 and further comprising downloading said data generally in parallel from a plurality of said information sources by light transmission to at least one receiver.

14. The method according to claim 1 wherein said light transmission comprises presenting a plurality of synthetic images that include said data.

15. The method according to claim 1 wherein said presenting comprises displaying said images on a screen synchronously with a refresh process of said screen.

16. The method according to claim 15 wherein said displaying comprises using a plurality of memory image-buffers, wherein contents of one of said buffers is displayed on the screen while contents of the other buffers are background updated.

17. The method according to claim 16 and further comprising switching between said buffers after background updating contents of the other buffers.

18. Apparatus comprising:
an information source displayable on a scan display screen and a non-scan display screen; and
a receiver adapted to download data from said information source by light transmission thereto.

19. Apparatus according to claim 18 and fixer comprising a transmitter adapted to transmit said data on at least one of a scan display screen and a non-scan display screen.

20. Apparatus according to claim 19 wherein said transmitter comprises an encoder adapted to encode said data from said information source into at least one-dimensional image information.

21. Apparatus according to claim 20 wherein said transmitter comprises a screen driver adapted to display said at least one-dimensional image information on a screen.

22. Apparatus according to claim 21 wherein said screen driver comprises a cathode ray tube (CRT) driver.

23. Apparatus according to claim 22 and fiber comprising a CRT screen in communication with said screen driver.

24. Apparatus according to claim 21 wherein said screen driver comprises a liquid crystal display (LCD) driver.

25. Apparatus according to claim 22 and further comprising an LCD screen in communication with said screen driver.

26. Apparatus according to claim 18 wherein said receiver comprises a photo sensor adapted to collect an emission of light from at least one of a scan display screen and a non-scan display screen.

27. Apparatus according to claim 26 wherein said receiver comprises a filter adapted to filter emission from any combination of said scan and non-scan display screens to a common reception level.

28. Apparatus according to claim 19 wherein said transmitter is adapted to modulate said light transmission of said data.

29. Apparatus according to claim 28 wherein said transmitter is adapted to modulate said light transmission in accordance with at least one of pulse modulation (PM), pulse place modulation (PPM), pulse width modulation (PWM), amplitude modulation (AM), return to zero (RZ), non-return to zero (NRZ) and binary interval modulation.

30. Apparatus according to claim 28 wherein said transmitter is adapted to change said light transmission between a plurality of gray levels displayable on a screen.

31. Apparatus according to claim 30 wherein said transmitter is adapted to represent a bit of data by at least one of a dark-to-light transition and a light-to-dark transition.

32. Apparatus according to claim 31 wherein said transmitter is adapted to represent said bit by a time interval between two adjacent transitions.

33. Apparatus according to claim 18 wherein said receiver further comprises a decoder adapted to decode said light transmission received by said receiver back to said data.

34. Apparatus according to claim 33 wherein said light transmission is characterized by a transfer characteristic function, and said decoder is adapted to decode said light transmission back to said data by determining an inverse of said transfer characteristic function.

35. Apparatus according to claim 34 wherein said decoder is adapted to decode said light transmission back to said data by estimating said inverse of said transfer characteristic function by means of a Look-Up-Table (LUT).

36. Apparatus according to claim 28 wherein said transmitter is adapted to dither said light transmission.

37. Apparatus according to claim 28 wherein said transmitter is adapted to separate said light transmission into a plurality of spectral colors.

38. Apparatus according to claim 18 wherein said receiver is disposed in a component of at least one subscriber identity module (SIM) card of a mobile phone.

39. Apparatus according to claim 38 wherein said component comprises a battery of said at least one SIM card.

40. Apparatus according to claim 33 and further comprising a device in communication with said receiver, said device being operable by means of the data decoded by said decoder.

41. Apparatus according to claim 40 wherein said device comprises at least one of an irrigation controller, a smart card, a credit card, an electronic coupon, a programmable portable device, a controller, a toy, a personal digital assistant (PDA), a video verification device, a video watermarking device, a loadable greeting card and a loadable multimedia device.

42. Apparatus according to claim 18 wherein said receiver comprises a plurality of photo sensors adapted to collect an emission of light generally in parallel from a plurality of said information sources by light transmission to said photo sensors.

43. Apparatus according to claim 42 wherein said photo sensors comprise at least one of a one-dimensional photo sensor, a two dimensional photo sensor, and a CCD sensor.

44. A method comprising:
receiving a plurality of signals from a scan screen, said signals comprising light segments; and
decoding the segments by deter a residual light effect of at least one of said light segments on a next light segment and subtracting said residual light effect from the received signals.

45. The method according to claim 44 wherein said determining comprises determining a segment pulse shape of one of said light segments.

46. The method according to claim 44 wherein said determining comprises determining a timing sequence of one of said light segments.

47. The method according to claim 45 wherein said determining said segment pulse shape comprises analyzing a pulse shape of at least one of said light segments by transmitting a single segment pulse with a known gray level, followed by transmitting a black screen.

48. The method according to claim 47 and further comprising decoding at least one of a shape and timing of said segment pulse with a pulse height and placement decoding unit.

49. The method according to claim 48 and her comprising storing said at least one of the shape and timing of said segment pulse in a decoded pulse FIFO (first in, first out) memory unit.

50. The method according to claim 49 and further comprising correcting non-linearity of at least one of said light segments.

51. The method according to claim 50 wherein said correcting comprises correcting wit a Look-Up-Table LUT).

52. The method according to claim 50 wherein said correcting comprises correcting by dithering at least one of said light segments.
